(19) United States
(12) Patent Application Publication
(10) Pub. No.: US 2009/0073106 A1
(43) Pub. Date: Mar. 19, 2009

(54) LIQUID CRYSTAL DISPLAY APPARATUS

(75) Inventor: Seiji KAWAGUCHI, Osaka (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Toshiba Matsushita Display Technology Co., Ltd, Tokyo (JP)

(21) Appl. No.: 12/209,454

(22) Filed: Sep. 12, 2008

(30) Foreign Application Priority Data
Sep. 19, 2007 (JP) 2007-242573

(51) Int. Cl. G09G 3/36

(52) U.S. Cl. 345/101

(57) ABSTRACT

In a liquid crystal display apparatus of an OCB type, a frame inversion drive is carried out to invert the polarities of a white level voltage and a black level voltage in conformity with the polarity of an opposed voltage on the frame-to-frame basis, so that the amplitudes of the black level voltage and the white level voltage decrease with rise in environmental temperature.

### CROSS-REFERENCE TO RELATED APPLICATIONS

This application is based upon and claims the benefit of priority from the prior Japanese Patent Application No. 2007-242573, filed on Sep. 19, 2007; the entire contents of which are incorporated herein by reference.

### TECHNICAL FIELD

The present invention relates to a liquid crystal display apparatus.

### BACKGROUND OF THE INVENTION

In recent years, a liquid crystal display apparatus employing an OCB (Optically Self-compensated Birefringence) mode is proposed in addition to a liquid crystal display apparatus employing a TN mode (for example, see JP-A-2003-29303 (KOKAI)).

The characteristic of the liquid crystal display apparatus of the OCB type is that application of a black writing voltage (black display voltage) is required before applying a video signal because transfer from a spray alignment to a bent alignment is required before displaying an image. When the black writing voltage is not applied or when the voltage is lower than the black writing voltage, a reverse transfer occurs and the alignment is returned to the spray alignment.

The black writing voltage has a characteristic to vary with the environmental temperature of the liquid crystal display apparatus, and decrease when the environmental temperature rises.

As described above, in the liquid crystal display apparatus of the OCB type, it is necessary to change the black writing voltage according to the environmental temperature. Referring now to FIG. 7, a method in the related art therefor will be described.

FIG. 7A shows a case where the environmental temperature is 20° C., and FIG. 7B shows a case where the environmental temperature is 70° C.

When the environmental temperature is 20° C., the polarities of the black level voltage and the white level voltage are inverted according to the opposed voltage whose polarity is inverted on the frame-to-frame basis. In this case, the black level voltage and the white level voltage are inverted at the same potential.

However, when the environmental temperature rises to 70° C., the black writing voltage decreases, and the black level voltage is also changed correspondingly. In other words, when the opposed voltage has a positive polarity, the black level voltage is increased in order to decrease the black writing voltage as the difference between the opposed voltage and the black level voltage. In contrast, when the opposed voltage has a negative polarity, the black level voltage is decreased to decrease the black writing voltage as the voltage difference therebetween.

Accordingly, even though the gamma characteristic of liquid crystal is changed with variations in environmental temperature, a tone inversion does not occur, and hence deterioration of the image quality does not occur.

However, in the method in the related art as described above, when the black level voltage is decreased at a high temperature, the black writing voltage for preventing the reverse transfer is also decreased correspondingly. Therefore, the reverse transfer due to the drop of the voltage may occur.

### BRIEF SUMMARY OF THE INVENTION

In view of such problems, it is an object of the invention to provide a liquid crystal display apparatus in which deterioration of the image quality does not occur even when the environmental temperature varies.

According to embodiments of the invention, there is provided a liquid crystal display apparatus including: a liquid crystal cell including an array substrate having a plurality of data lines, a plurality of gate lines arranged to be orthogonal to the data lines, and switching elements formed near intersections of the data lines and the gate lines, and pixels arranged in a matrix pattern, an opposed substrate having an opposed electrode, and liquid crystal filled between the both substrates; a backlight arranged on the back side of the liquid crystal cell; a temperature detecting unit configured to detect the environmental temperature of the liquid crystal display apparatus; an opposed voltage application unit configured to apply an opposed voltage to the opposed electrode while inverting the polarity on the frame-to-frame basis; and a data line voltage application unit configured to (1) generate a plurality of tone voltages from a black level voltage to a white level voltage and applies a tone voltage corresponding to an entered video signal to the respective data lines as a writing voltage so as to cause the polarity to be inverted on the frame-to-frame basis, (2) decrease the amplitude of the black level voltage in proportion to the rise in the detected temperature, (3) decrease the amplitude of the white level voltage in proportion to the rise in the detected temperature, (4) apply a black writing voltage in a first term of the one frame, (5) apply a video writing voltage in a second term of the one frame, (6) apply a video holding voltage in a third term of the one frame, and (7) invert the polarities of the black writing voltage, the video writing voltage, and the video holding voltage on the frame-to-frame basis.

The invention also provides a liquid crystal display apparatus including: a liquid crystal cell including an array substrate having a plurality of data lines, a plurality of gate lines arranged to be orthogonal to the data lines, and switching elements formed near intersections of the data lines and the gate lines, and pixels arranged in a matrix pattern, an opposed substrate having an opposed electrode, and liquid crystal filled between the both substrates; a backlight arranged on the back side of the liquid crystal cell; a temperature detecting unit configured to detect the environmental temperature of the liquid crystal display apparatus; an opposed voltage application unit configured to apply an opposed voltage to the opposed electrode while inverting the polarity on the frame-to-frame basis; and a data line voltage application unit configured to (1) generate a plurality of tone voltages from a black level voltage to a white level voltage and applies a tone voltage corresponding to an entered video signal to the respective data lines as a writing voltage so as to cause the polarity to be inverted on the frame-to-frame basis, (2) apply a black writing voltage in a first term of the one frame, (3) apply a video writing voltage in a second term of the one frame, (4) apply a video holding voltage in a third term of the one frame, (5) invert the polarities of the black writing voltage, the video writing voltage, and the video holding voltage on the frame-to-frame basis, and (6) decrease the amplitude of the black level voltage in the first term to the amplitude smaller than the amplitudes of the black level voltage in the second term and the third term in proportion to the rise in the detected temperature; and a turn ON and OFF control unit configured to turn OFF the backlight in the first term and the second term in the one frame and turn ON the backlight in the third term.

The invention also provides a liquid crystal display apparatus including: a liquid crystal cell including an array substrate having a plurality of data lines, a plurality of gate lines arranged to be orthogonal to the data lines, and switching elements formed near intersections of the data lines and the gate lines, and pixels arranged in a matrix pattern, an opposed substrate having an opposed electrode, and liquid crystal filled between the both substrates; a backlight arranged on the back side of the liquid crystal cell; a temperature detecting unit configured to detect the environmental temperature of the liquid crystal display apparatus; an opposed voltage application unit configured to apply an opposed voltage to the opposed electrode while inverting the polarity on the frame-to-frame basis; and a data line voltage application unit configured to (1) generate a plurality of tone voltages from a black level voltage to a white level voltage and applies a tone voltage corresponding to an entered video signal to the respective data lines as a writing voltage so as to cause the polarity to be inverted on the frame-to-frame basis, (2) apply a black writing voltage in a first term of the one frame, (3) apply a video writing voltage in a second term of the one frame, (4) apply a video holding voltage in a third term of the one frame, (5) invert the polarities of the black writing voltage, the video writing voltage, and the video holding voltage on the frame-to-frame basis, and (6) delay the inversion timing of the polarity by a length corresponding to the first term in comparison with the inversion timing of the opposed voltage and decreases the amplitude of the black level voltage in proportion to the rise in the detected temperature; and a turn ON and OFF control unit configured to turn OFF the backlight in the first term and the second term in the one frame and turn ON the backlight in the third term.

According to the invention, deterioration of the image quality does not occur even when the environmental temperature rises.

### BRIEF DESCRIPTION OF THE DRAWINGS

FIG. 1 is a block diagram showing a liquid crystal display apparatus of an OCB type according to a first embodiment of the invention;

FIG. 2 is a circuit diagram of a gamma circuit of a source driver;

FIG. 3 illustrates a state of a signal in one frame showing a pixel writing state;

FIG. 4A is a graph of respective voltage in each frame at an environmental temperature of 20° C.;

FIG. 4B is a graph of respective voltage in each frame at an environmental temperature of 70° C.;

FIG. 5A is a graph of respective voltage in each frame at an environmental temperature of 20° C. according to a second embodiment;

FIG. 5B is a graph of respective voltage in each frame at an environmental temperature of 70° C. according to the second embodiment;

FIG. 6A is a graph of respective voltage in each frame at an environmental temperature of 20° C. according to a third embodiment;

FIG. 6B is a graph of respective voltage in each frame at an environmental temperature of 70° C. according to the third embodiment;

FIG. 7A is a graph of respective voltage in each frame at an environmental temperature of 20° C. in the related art; and

FIG. 7B is a graph of respective voltage in each frame at an environmental temperature of 70° C. in the related art.

### DETAILED DESCRIPTION OF THE INVENTION

Referring now to the drawings, embodiments of a liquid crystal panel 10 of an OCB type according to the invention will be described individually.

### First Embodiment

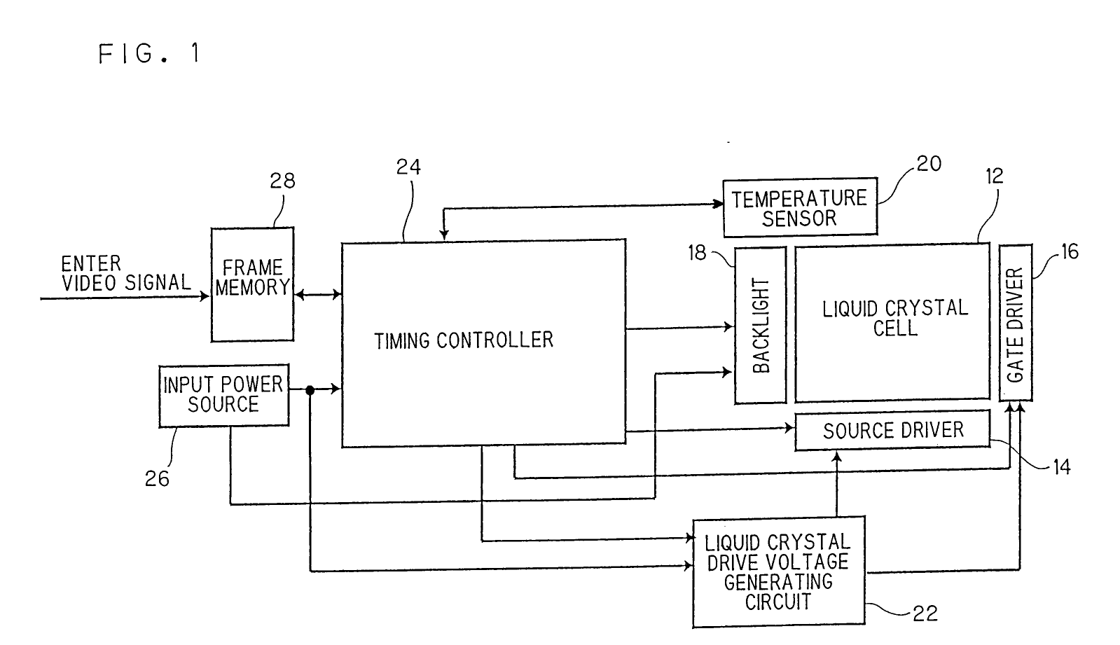

Referring now to FIG. 1 to FIG. 4B, the liquid crystal panel 10 of the OCB type according to a first embodiment of the invention will be described.

Referring now to FIG. 1, a configuration of the liquid crystal panel 10 will be described.

A liquid crystal cell 12 of the liquid crystal panel 10 in the first embodiment includes an array substrate and an opposed substrate arranged so as to oppose to each other, and OCB liquid crystal interposed therebetween. The array substrate includes a plurality of data lines, gate lines extending orthogonally thereto, thin film transistors (hereinafter, referred to as TFT) formed of polysilicon type semiconductor formed near the intersections of the data lines and the gate lines, thereby configuring pixels. The pixels are arranged in a matrix pattern on the entire array substrate.

An opposed electrode is formed over the entire surface of the opposed substrate.

A source driver 14 connected to the respective data lines is arranged on the X-side of the liquid crystal cell 12, and a gate driver 16 connected to the respective gate lines is provided on the Y-side of the liquid crystal cell 12.

A backlight 18 for illuminating the liquid crystal cell 12 is arranged on the back side of the liquid crystal cell 12. A temperature sensor 20 for detecting the environmental temperature of the liquid crystal display apparatus is arranged in the vicinity of the liquid crystal cell 12.

The liquid crystal panel 10 further includes a liquid crystal drive voltage generating circuit 22 for supplying a drive voltage to the source driver 14 and the gate driver 16, and a timing controller 24. The timing controller 24 and the liquid crystal drive voltage generating circuit 22 receive drive voltages from an input power source 26. The liquid crystal drive voltage generating circuit 22 also supplies an opposed voltage to the opposed electrode on the opposed substrate.

Analog video signals from the outside enter a frame memory 28, and video signals temporarily accumulated in the frame memory 28 are entered to the timing controller 24 in conformity with clock signals. In the timing controller 24, for example, video signals, horizontal clock signals, and start signals are supplied to the source driver 14, and vertical clock signals for generating gate signals are supplied to the gate driver 16. The timing controller 24 receives temperature signals from the temperature sensor 20 and controls turning ON and OFF of the backlight 18.

Subsequently, a configuration of a gamma circuit (tone voltage generating circuit) 30 built in the source driver 14 will be described.

The liquid crystal panel 10 inverts the frame as described later, and hence includes a gamma circuit 32 on the positive polarity and a gamma circuit 34 on the negative polarity, so that a changeover switch is activated by a switching signal, not shown, at each inversion of the frame, and the output is switched alternately.

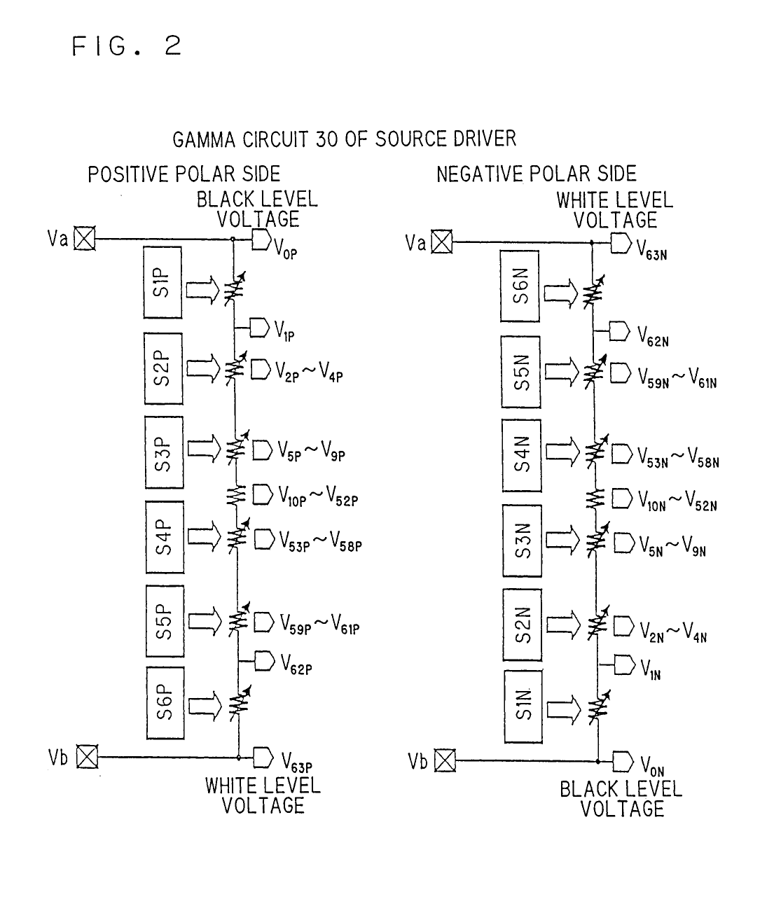

As shown in FIG. 2, a first voltage Va is applied to the gamma circuit 32 on the positive polarity as a black voltage, and a second voltage Vb is applied thereto as a white level voltage. For example, seven variable resistances R are connected in series so as to allow output of 64 tone voltages V0P to V63P between these voltages, so that output of the tone voltages for the connected each terminal is enabled. For example, the tone voltage V0P outputted directly from the black level voltage Va is a black level voltage, and a voltage V1P for the first tone is outputted through one variable resistance R1. Likewise, output of the voltages of 64 tones to V63P which is the same as the white level voltage Vb is allowed while adjusting the variable resistance R.

Although the gamma circuit 34 on the negative polarity also has a similar configuration to the gamma circuit 32 on the positive polarity, it is different in that the first voltage Va is applied to the white level voltage and the second voltage Vb is applied to the black level voltage.

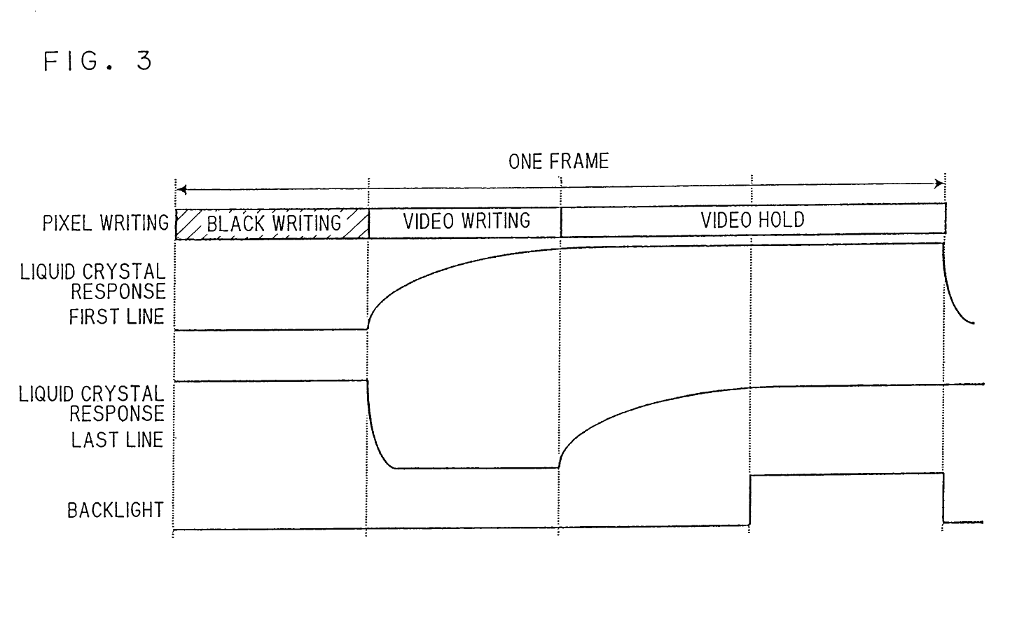

Referring now to FIG. 3, a display state of the liquid crystal panel 10 of the OCB type will be described.

In the liquid crystal panel 10 of the OCB type in the first embodiment, the frame inversion drive is carried out, the one frame is divided into three terms of a first term as a black writing period, a second term as a video writing period, and a third term as a video holding period. The polarity of the opposed voltage is inverted on the frame-to-frame basis.

As shown in FIG. 3, in a first line of the liquid crystal cell 12, a black writing voltage is applied in the first term. A video writing voltage as the tone voltage corresponding to the video signal is applied in the second term. A video holding voltage for holding the video is applied in the third term. The video holding voltage is the same voltage as the video writing voltage.

In this manner, the black writing voltage, the video writing voltage, and the video holding voltage are applied in each line, and the same procedure is carried out to the last line.

The backlight 18 is kept in a state of being turned OFF until the entire video from the first line to the last line is written, and is turned ON when the entire video signal is written.

Accordingly, deterioration of the image quality is avoided because a tone inversion while writing the signal does not occur during the first term and the second term and, in addition, black insertion is carried out, and the visibility of the moving image is also improved.

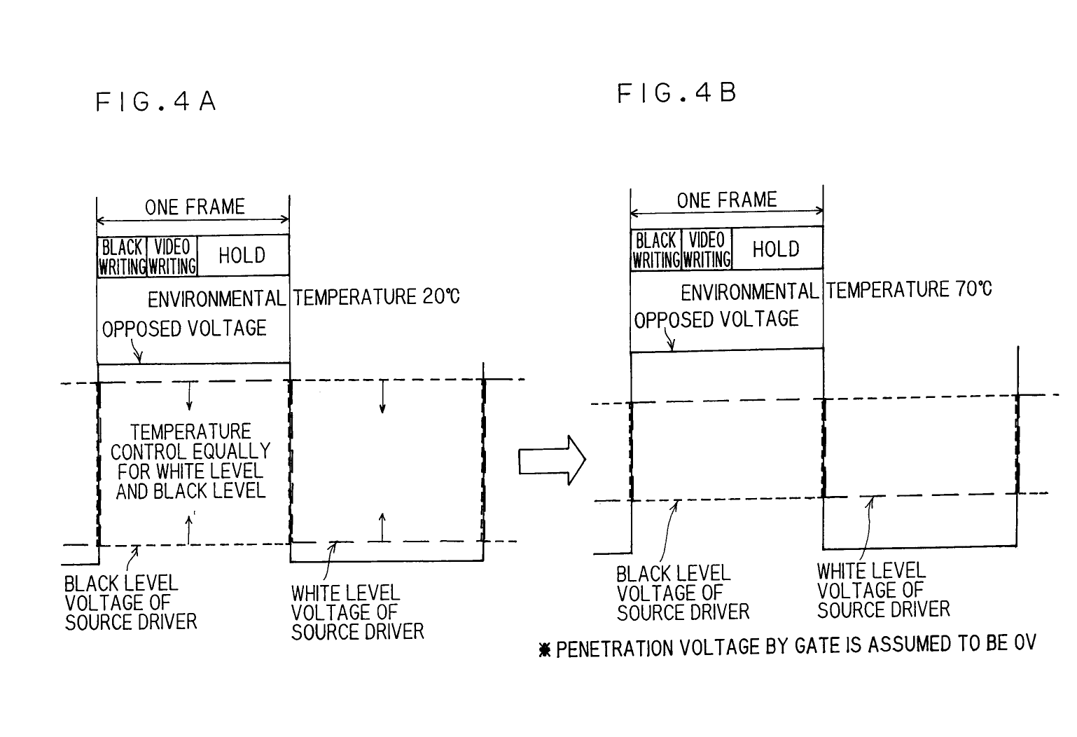

Referring now to FIGS. 4A and 4B, a method of controlling in a case where the environmental temperature varies will be described. FIGS. 4A and 4B are drawings assuming that a penetration voltage by the gate is 0V.

As described above, in the liquid crystal panel 10 of the OCB type, when the environmental temperature increases, the black display voltage decreases. Therefore, the more the environmental temperature rises from a reference temperature (for example, 20° C.), the more necessity of decreasing the black writing voltage increases. Therefore, as shown in FIG. 4A, the amplitude of the black level voltage is maximized at an environmental temperature of 20° C., and the amplitude of the black level voltage decreases with increase in environmental temperature. The black writing voltage corresponds to the potential difference between the opposed voltage and the black level voltage.

In addition, in the first embodiment, the amplitude of the white level voltage at an environmental temperature of 20° C. is maximized, and the amplitude of the white level voltage decreases with the rise in environmental temperature as in the case of the black level voltage.

In this configuration, the minimum luminance is achieved without occurrence of the tone inversion in the black display even when the environmental temperature rises. In addition, although the black writing voltage decreases at a high temperature in the white display, the white voltage increases, so that a reverse transfer which is specific in the OCB is prevented.

Although the change in amplitude of the black level voltage and the change in amplitude of the white level voltage may be different, the gamma circuit in FIG. 2 is simplified by setting in such a manner that the smaller the range of the black level voltage is, the smaller the range of the white level voltage becomes correspondingly. In other words, the black level voltage of the gamma circuit 32 on the positive polarity and the white level voltage of the gamma circuit 34 on the negative polarity are set to be the same potential Va, the white level voltage of the gamma circuit 32 on the positive polarity and the black level voltage of the gamma circuit 34 on the negative polarity are set to the same potential Vb, the first voltage Va decreases together with the detected temperature by the temperature sensor 20, and the second voltage Vb decreases together with the detected temperature in the same manner, so that the values of the amplitude of the black level voltage and the white level voltage decrease in the same manner even though the frame inversion drive is carried out.

In the first embodiment, the backlight 18 is turned ON only in the third term. However, in the first embodiment, the image is clearly displayed even when the image is displayed with the backlight 18 turned ON in the first to third terms, that is, in all the terms. The reason is that the tone inversion does not occur both in the black writing period and the video writing period.

### Second Embodiment

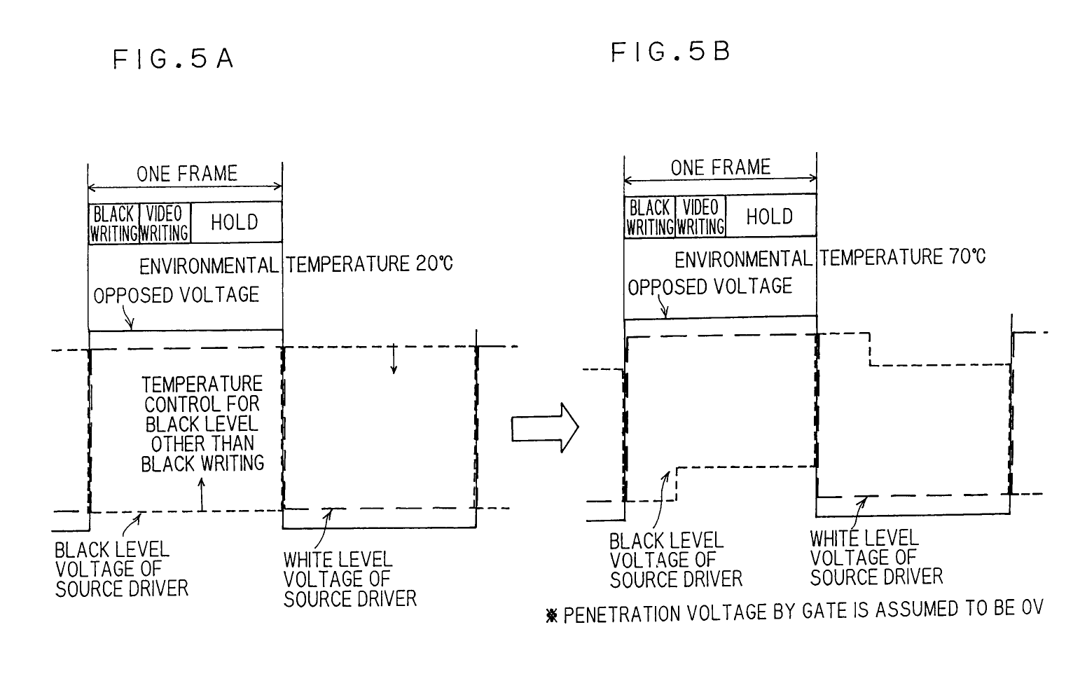

Referring now to FIGS. 5A and 5B, the liquid crystal panel 10 of the OCB type according to a second embodiment will be described.

A different point of the second embodiment from the first embodiment is in the method of applying the black level voltage and the white level voltage.

In the first embodiment, the amplitudes of the white level voltage and the black level voltage decrease with the environmental temperature. However, the amplitude of the white level voltage is constant irrespective of the environmental temperature in the second embodiment.

In contrast, the black level voltage has the maximum amplitude irrespective of the environmental temperature during the first term (black writing period), and the amplitude of the black level voltage in the second term and the third term decreases with the environmental temperature. In addition, the backlight 18 is turned OFF during the first term and the second term, and is turned ON only during the third term.

In this configuration, since the voltage in the black writing period is constant even at a high temperature at which the reverse transfer is apt to occur, the reverse transfer does not occur. In contrast, since the amplitude of the black level voltage decreases according to the environmental temperature during the video writing period and the video holding period for displaying the video, the tone inversion does not occur.

Although the reverse transfer does not occur in the black writing period because the black level voltage is constant irrespective of the environmental temperature, the tone inversion may occur. However, since the backlight 18 is turned OFF during the first term and the second term, it is invisible for users.

### Third Embodiment

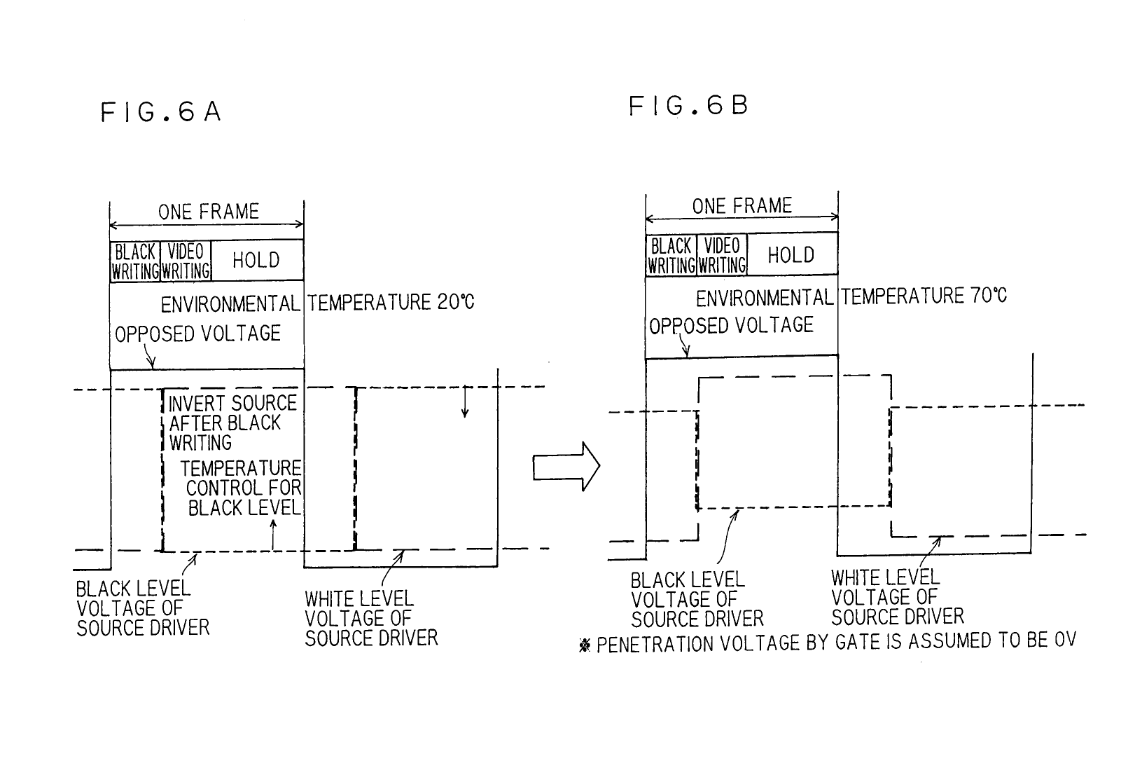

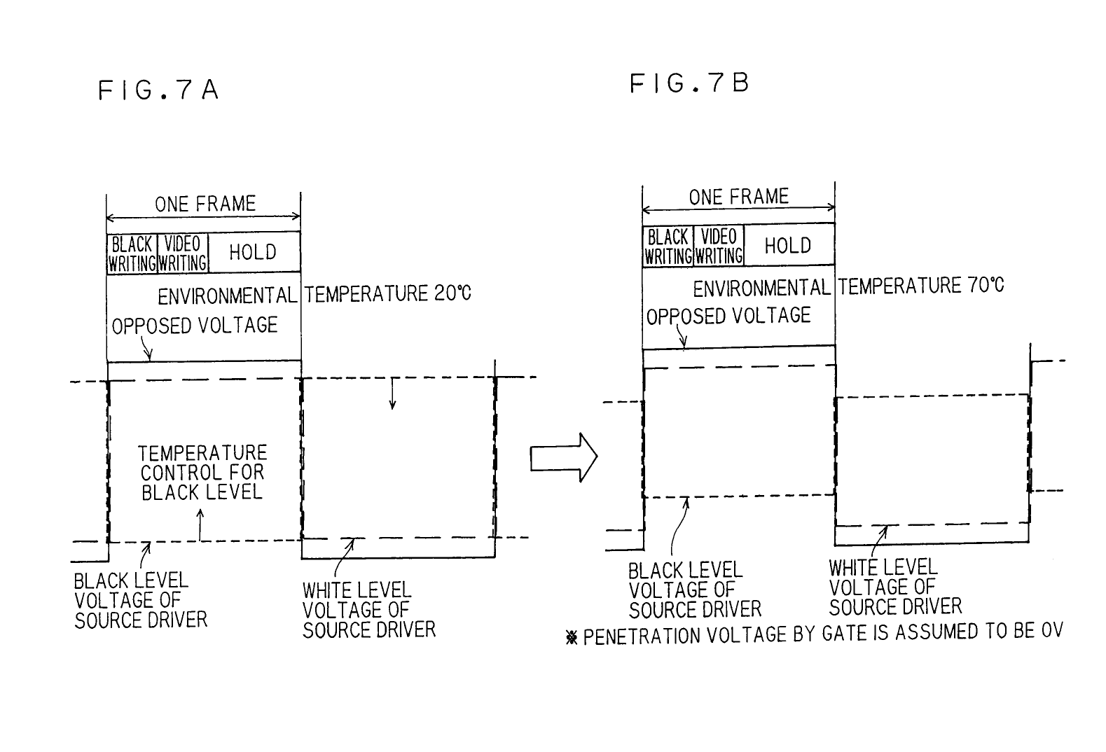

Referring now to FIGS. 6A and 6B, the liquid crystal panel 10 of the OCB type according to a third embodiment will be described.

A different point of the third embodiment from the first embodiment is in the method of applying the black level voltage and the white level voltage which vary with the environmental temperature.

FIG. 6A shows a case in which the environmental temperature is 20° C., and the FIG. 6B shows a case in which the environmental temperature is 70° C.

The third embodiment is characterized in that the polarity of the opposed voltage is inverted on the frame-to-frame basis. In other words, the polarity is the same in the first term, the second term, and the third term.

In contrast, the black level voltage and the white level voltage are shifted in timing of inverting the frame from the opposed voltage, so that the polarities of the second term, the third term, and the first term of a next frame are the same and are inverted. The higher the environmental temperature rises, the smaller the amplitude of only the black level voltage becomes, and the amplitude of the white level voltage is kept constant irrespective of the environmental temperature. In other words, the polarity inversion is carried out after the first term (black writing period) and the black writing is carried out at the white level voltage of the previous frame, so that the potential difference from the opposed voltage is maximized independently of the environmental temperature.

The backlight 18 is turned OFF during the first term and the second term, and is turned ON only during the third term.

In this configuration, since the white level voltage is constant irrespective of the environmental temperature, the white level voltage in the previous frame is the same as the maximum value of the black writing voltage in the current frame. It is caused by the specific characteristic of the opposed voltage inversion drive for inverting the opposed voltage. Accordingly, the video display without reverse transfer is achieved even at a high temperature. Since the backlight 18 is turned OFF in the first term and the second term, even when the black writing voltage increases to a level higher than the threshold value, it is invisible for the users.

### Modification

The invention is not limited to the embodiments described above, and may be modified variously without departing from the scope of the invention. For example, the invention may be applied to liquid crystal other than the OCB type as long as high-speed response is possible.

What is claimed is:

1. A liquid crystal display apparatus comprising:
a liquid crystal cell including:
an array substrate having a plurality of data lines, a plurality of gate lines arranged to be orthogonal to the data lines, and switching elements formed near intersections of the data lines and the gate lines, and pixels arranged in a matrix pattern;
an opposed substrate having an opposed electrode; and
liquid crystal filled between the both substrates;
a backlight arranged on the back side of the liquid crystal cell;
a temperature detecting unit configured to detect the environmental temperature of the liquid crystal display apparatus;
an opposed voltage application unit configured to apply an opposed voltage to the opposed electrode while inverting the polarity on the frame-to-frame basis; and
a data line voltage application unit configured to (1) generate a plurality of tone voltages from a black level voltage to a white level voltage and applies a tone voltage corresponding to an entered video signal to the respective data lines as a writing voltage so as to cause the polarity to be inverted on the frame-to-frame basis, (2) decrease the amplitude of the black level voltage in proportion to the rise in the detected temperature, (3) decrease the amplitude of the white level voltage in proportion to the rise in the detected temperature, (4) apply a black writing voltage in a first term of the one frame, (5) apply a video writing voltage in a second term of the one frame, (6) apply a video holding voltage in a third term of the one frame, and (7) invert the polarities of the black writing voltage, the video writing voltage, and the video holding voltage on the frame-to-frame basis.

2. The liquid crystal display apparatus according to claim 1, wherein the data line voltage application unit decreases the amplitude of the black level voltage and the amplitude of the white level voltage by the same ratio.

3. The liquid crystal display apparatus according to claim 1, wherein a turn ON and OFF control unit of the backlight turns the backlight OFF during the first term and the second term in the one frame, and turns ON in the third term.

4. The liquid crystal display apparatus according to claim 1, wherein the liquid crystal is OCB liquid crystal.

5. A liquid crystal display apparatus comprising:
a liquid crystal cell including:
an array substrate having a plurality of data lines, a plurality of gate lines arranged to be orthogonal to the data lines, and switching elements formed near intersections of the data lines and the gate lines, and pixels arranged in a matrix pattern,
an opposed substrate having an opposed electrode, and
liquid crystal filled between the both substrates;
a backlight arranged on the back side of the liquid crystal cell;
a temperature detecting unit configured to detect the environmental temperature of the liquid crystal display apparatus;
an opposed voltage application unit configured to apply an opposed voltage to the opposed electrode while inverting the polarity on the frame-to-frame basis; and
a data line voltage application unit configured to (1) generate a plurality of tone voltages from a black level voltage to a white level voltage and applies a tone voltage corresponding to an entered video signal to the respective data lines as a writing voltage so as to cause the polarity to be inverted on the frame-to-frame basis, (2) apply a black writing voltage in a first term of the one frame, (3) apply a video writing voltage in a second term of the one frame, (4) apply a video holding voltage in a third term of the one frame, (5) invert the polarities of the black writing voltage, the video writing voltage, and the video holding voltage on the frame-to-frame basis, and (6) decrease the amplitude of the black level voltage in the first term to the amplitude smaller than the amplitudes of the black level voltage in the second term and the third term in proportion to the rise in the detected temperature; and
a turn ON and OFF control unit configured to turn OFF the backlight in the first term and the second term in the one frame and turn ON the backlight in the third term.

6. The liquid crystal display apparatus according to claim 5, wherein the liquid crystal is OCB liquid crystal.

7. A liquid crystal display apparatus comprising:
a liquid crystal cell including
an array substrate having a plurality of data lines, a plurality of gate lines arranged to be orthogonal to the data lines, and switching elements formed near intersections of the data lines and the gate lines, and pixels arranged in a matrix pattern,
an opposed substrate having an opposed electrode, and
liquid crystal filled between the both substrates;
a backlight arranged on the back side of the liquid crystal cell;
a temperature detecting unit configured to detect the environmental temperature of the liquid crystal display apparatus;
an opposed voltage application unit configured to apply an opposed voltage to the opposed electrode while inverting the polarity on the frame-to-frame basis; and
a data line voltage application unit configured to (1) generate a plurality of tone voltages from a black level voltage to a white level voltage and applies a tone voltage corresponding to an entered video signal to the respective data lines as a writing voltage so as to cause the polarity to be inverted on the frame-to-frame basis, (2) apply a black writing voltage in a first term of the one frame, (3) apply a video writing voltage in a second term of the one frame, (4) apply a video holding voltage in a third term of the one frame, (5) invert the polarities of the black writing voltage, the video writing voltage, and the video holding voltage on the frame-to-frame basis, and (6) delay the inversion timing of the polarity by a length corresponding to the one term in comparison with the inversion timing of the opposed voltage and decreases the amplitude of the black level voltage in proportion to the rise in the detected temperature; and
a turn ON and OFF control unit configured to turn OFF the backlight in the first term and the second term in the one frame and turn ON the backlight in the third term.

8. The liquid crystal display apparatus according to claim 7, wherein the liquid crystal is OCB liquid crystal.
